(19) United States
(12) Patent Application Publication
(10) Pub. No.: US 2008/0186209 A1
(43) Pub. Date: Aug. 7, 2008

(54) Method of Providing Related Information of a Remote Location on a Guiding System in a Real-Time Manner

(76) Inventors: Chien-Yang Chang, Taoyuan County (TW); Kung-Kuei Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/775,856

(22) Filed: Jul. 10, 2007

(30) Foreign Application Priority Data
Feb. 7, 2007 (TW) 096104448

(51) Int. Cl. G08G 1/123; G01C 21/00

(52) U.S. Cl. 340/988; 340/995.27; 701/207

(57) ABSTRACT

When a driver searches for related information about targets around a destination with a guiding system, the guiding system does not need to deactivate a guiding function when the guiding system begins searching for the related information. The driver is merely required to set both values of a first distance and a second distance right after the driver sets an identity of the destination, where both the first distance and the second distance indicate a fact that when the driver reaches less than said first distance away from the destination, the guiding system begins searching for the related information of the targets, which are less than said second distance away from the destination.

### BACKGROUND OF THE INVENTION

1. Field of the Invention

The present invention relates to a method of providing related information of a remote location, and more particularly, to a method of providing related information of a remote location on a guiding system in a real-time manner.

2. Description of the Prior Art

Conventional guiding systems are popularly equipped on vehicles, for providing drivers of the vehicles route-related information. It indicates an original purpose for designing such conventional guiding systems. A most popular conventional guiding system is the global positioning system (GPS), which has been widely used on medium-sized and small-sized vehicles such as a car. However, with increase of requirements of users in guiding systems, a user may need certain information about his targets. Moreover, some guiding systems have been capable of providing functions of searching certain information for users with the aid of connections with databases on networks. For example, when a driver drives a car halfway to a shopping mall, the driver may need information about parking areas around the shopping mall. The information includes existences and locations of the parking areas. When the driver would like to fuel his car up nearby the shopping mall, the information includes existences and locations of gas stations around the shopping mall. When the user searches the abovementioned information about the shopping mall, he has to deactivate guiding functions of the guiding system before he activates functions of searching point of interest (POI). However, it may depress intentions of the user in searching points of interest before the guiding functions are deactivated because the user cannot search points of interest by following his own inclinations, and therefore, the convenience in searching points of interest is significantly depressed. Moreover, the functions of searching points of interest have to be activated manually by the user so that it takes the user additional steps and time spent waiting for the functions of searching the points of interest to be activated.

### SUMMARY OF THE INVENTION

The claimed invention discloses a method of providing related information of a remote location on a guiding system in a real-time manner. The method comprises setting a guiding system to detect a plurality of objects when a distance of the guiding system from a destination is less than a first distance, detecting related information of the plurality of objects, and displaying the detected related information of the plurality of objects on the guiding system. Distances of the plurality of objects from the destination are all less than a second distance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a method of providing related information of a remote location on a guiding system in a real-time manner in the present invention.

FIG. 2, FIG. 3, FIG. 4, and FIG. 5 illustrate searching related information and displaying the found related information on a user interface equipped on a guiding system according to steps illustrated in FIG. 1 when a driver would like to drive to the shopping mall and to search for the related information about parking areas around the shopping mall.

### DETAILED DESCRIPTION

For preventing the inconvenience that the user has to take additional steps and time for deactivating the guiding functions and activating functions of searching points of interest when the user would like to search information about his targets, a method of providing related information of a remote location on a guiding system in a real-time manner is disclosed in the present invention, where the disclosed method of the present invention is directly applied on the guiding system.

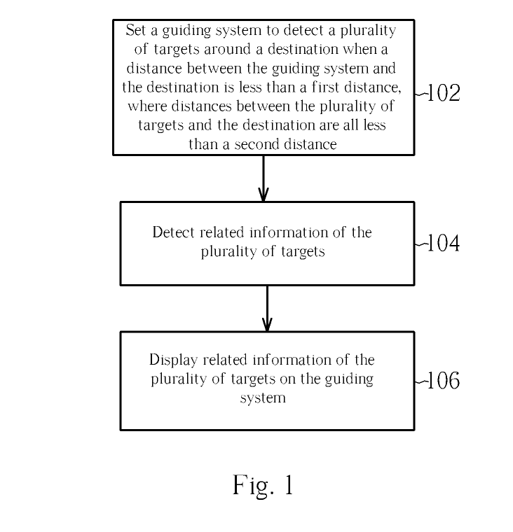

Please refer to FIG. 1, which is a diagram of the method of providing related information of a remote location on a guiding system in a real-time manner in the present invention. The steps illustrated in FIG. 1 are listed as follows:

Step 102: Set a guiding system to detect a plurality of targets around a destination when a distance between the guiding system and the destination is less than a first distance, where distances between the plurality of targets and the destination are all less than a second distance.

Step 104: Detect related information of the plurality of targets.

Step 106: Display related information of the plurality of targets on the guiding system.

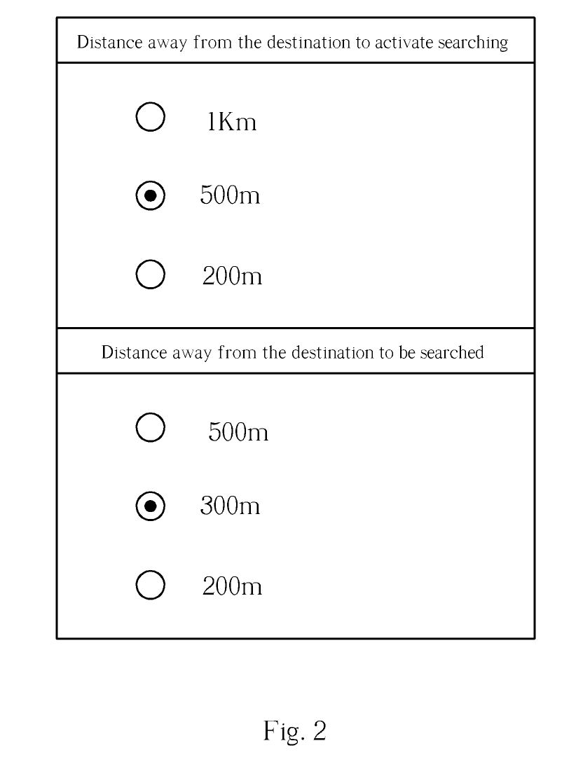

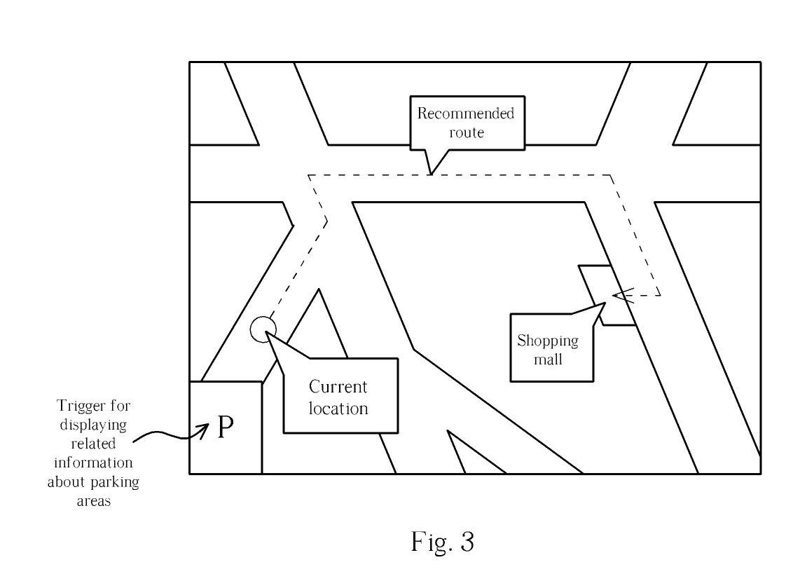

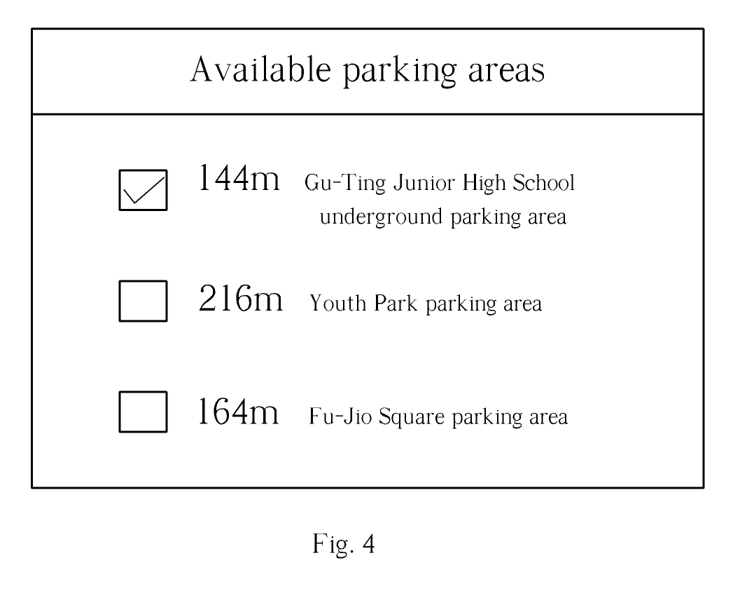

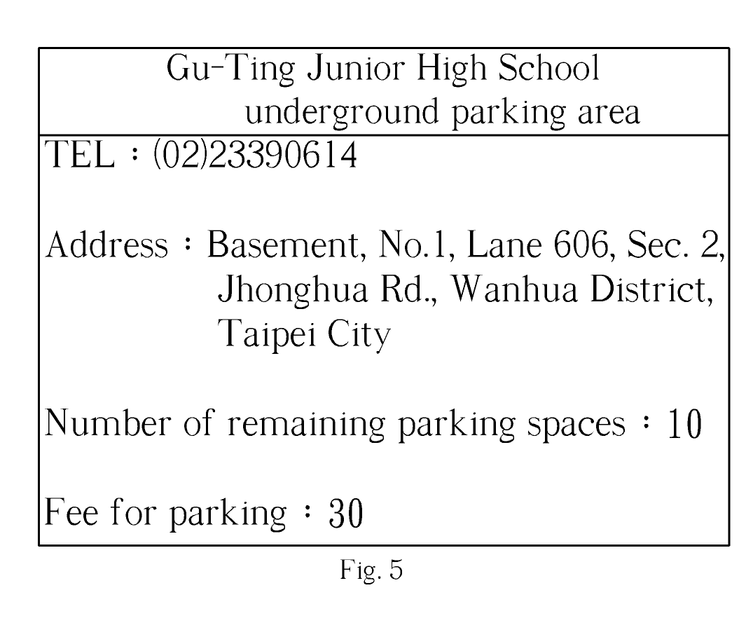

The steps in FIG. 1 are to be described under a situation that when the user drives his car to the shopping mall and would like to search parking areas around the shopping mall, and the situation is to be illustrated in FIG. 2, FIG. 3, FIG. 4, and FIG. 5 with a user interface equipped on the guiding system for displaying related information. Note that the situation illustrated in FIG. 2, FIG. 3, FIG. 4, and FIG. 5 is merely a specific situation of applying the method shown in FIG. 1, and moreover, other situations of applying the method shown in FIG. 1 should also be regarded as embodiments of the present invention.

When the driver drives his car halfway to the shopping mall and sets the shopping mall on the guiding system as his destination so that the guiding system indicates the driver with appropriate routes, as shown in FIG. 2, the driver may direct the guiding system to automatically search for existences and related information of parking areas less than three hundred meters away from the shopping mall at the same time after the guiding system is less than five hundred meters away from the parking areas. The shopping mall indicates the destination mentioned in Step 102. The distance of five hundred meters indicates the first distance mentioned in Step 102. The distance of three hundred meters indicates the second distance mentioned in Step 102. Note that although values of both the first and second distances are indicated with marks in FIG. 2, in other embodiments of the present invention, other techniques in inputting the values of both the first and second distances should not be limitations to the method of the present invention. For example, a keyboard equipped on the guiding system may also be inputted with the values of both the first and second distances directly according to an embodiment of the present invention.

When the driver reaches the distance less than five hundred meters away from the shopping mall, as illustrated in FIG. 3 and FIG. 4, the guiding system keeps on indicating appropriate routes for the driver and automatically searches existences and related information about parking areas in a distance less than three hundred meters away from the shopping mall at the same time, i.e., the guiding function of the guiding system is not deactivated. The guiding system hides the found existences and related information of the parking areas in advance until the drivers triggers the mark “P” illustrated on the monitor shown in FIG. 3 and utilized for indicating parking areas, and then displays the previous-hidden existences and related information of the parking areas on the monitor. FIG. 4 illustrates a list of available parking areas found by the guiding system. After the driver selects a specific parking area as illustrated on FIG. 4, as shown in FIG. 5, the guiding system displaying related information of the selected parking area in detail, such as a parking fee, a number of remaining parking spaces, a telephone number, and an address of the parking area. Note that related information of a parking area includes the location of the parking area. The abovementioned situation is merely a way in implementing Step 104 and Step 106.

Besides, after the guiding system begins searching targets, dynamic information about the searched targets is also required to be updated in the guiding system. In the abovementioned embodiment, when the existences of a plurality of parking areas are found and listed as illustrated in FIG. 4, and in a few minutes before the driver arrives at a selected parking area, a number of remaining parking spaces in the selected parking area may vary. Therefore, if the information about the number of remaining parking spaces is not updated dynamically in the guiding system, the driver may be misguided by the guiding system and lose a preemptive chance in making a more appropriate decision. For example, the number of remaining parking spaces is found to be zero at the time when the driver arrives at the selected parking area. For preventing such a circumstance and according to the method of the present invention, after the guiding system finds related information about the selected parking area, and before the driver arrives at the selected parking area, the guiding system keeps on tracking and updating related information of the selected parking area so that the driver gains a preemptive chance in making an advantageous decision of selecting parking areas.

Note that the user interfaces shown in FIG. 2, FIG. 3, FIG. 4, and FIG. 5 are merely an embodiment of applying the method of the present invention. Therefore, other embodiments about the shown user interfaces should not be limitations to the method of the present invention.

Applying the method of the present invention in a guiding system for searching related information about parking areas may be implemented with a local wireless network, and moreover, with a radio data system (RDS) for updating any related information that should be inform the driver dynamically. The radio data system, which is as known by those who skilled in the art, is a system for transmitting a fewer amount of digital messages with the frequency modulation (FM). The radio data system may also integrate several types of digital messages and transmit the integrated digital messages. Therefore, applying the radio data system on the guiding system for updating and searching dynamic information is beneficial.

A method of providing related information of a remote location in a real-time manner is disclosed in the present invention. With the aid of the disclosed method, a guiding system may keep on searching and dynamically updating related information of a destination of a driver without deactivating the guiding function of the guiding system. With the disclosed method, the driver does not have to deactivate the guiding function of the guiding system while the guiding system is ordered to search related information of the destination of the driver, additional manual steps of the driver are no longer necessary to be taken for searching for points of interest, and the guiding system may dynamically update any dynamic information and real-time situations that should inform the driver preemptively.

Those skilled in the art will readily observe that numerous modifications and alterations of the device and method may be made while retaining the teachings of the invention.

What is claimed is:

1. A method of providing related information of a remote location on a guiding system in a real-time manner comprising:
setting a guiding system to detect a plurality of objects when a distance of the guiding system from a destination is less than a first distance, wherein distances of the plurality of objects from the destination are all less than a second distance;
detecting related information of the plurality of objects; and
displaying the detected related information of the plurality of objects on the guiding system.

2. The method of claim 1 wherein detecting the related information of the plurality of objects comprises:
dynamically updating the related information of the plurality of objects; and
displaying the updated related information of the plurality of objects on the guiding system.

3. The method of claim 1 wherein detecting the related information of the plurality of objects comprises:
receiving and dynamically updating the related information of the plurality of objects with a radio data system (RDS).

4. The method of claim 1 wherein the plurality of objects are a plurality of parking areas, and the related information of the plurality of objects comprises remaining parking spaces of the plurality of parking areas.

5. The method of claim 4 further comprising:
hiding related information of the plurality of objects on the guiding system until a command of displaying the related information of said plurality of objects is triggered.

6. The method of claim 4 wherein the related information of the plurality of objects further comprises:
a fee for using a parking space of each of the plurality of parking areas;
a number of remaining parking spaces of each of the plurality of parking areas;
an address of each of the plurality of parking areas; and
telephone numbers of each of the plurality of parking areas.

7. The method of claim 1 wherein detecting the related information of the plurality of objects comprises:
receiving and dynamically updating related information of the plurality of objects with wireless networks.
